(19) United States
(12) Patent Application Publication
(10) Pub. No.: US 2013/0220985 A1
(43) Pub. Date: Aug. 29, 2013

(54) WELDING DEVICE

(71) Applicants: Hakan Larsson, Laxa (SE); Pasi Rajala, Laxa (SE)

(72) Inventors: Hakan Larsson, Laxa (SE); Pasi Rajala, Laxa (SE)

(73) Assignee: ESAB AB, Goteborg (SE)

(21) Appl. No.: 13/881,616

(22) PCT Filed: Oct. 28, 2010
(86) PCT No.: PCT/SE2010/051173

§ 371 Date: Apr. 25, 2013

(51) Int. Cl. B23K 9/095

(52) U.S. Cl. CPC B23K 9/0956
USPC 219/124.34

(57) ABSTRACT

A welding device applies weld material between two work pieces (P1, P2) so as to connect the work pieces (P1, P2) mechanically with one another. The welding device has a welding head (110) and a probe head (120). The welding head (110) performs a welding action in respect of the work pieces (P1, P2) during transport of the welding device along an operating direction (OD) in a welding plane (WP); and the probe head (120), which is arranged upstream of the welding head (110) relative to the operating direction (OD), measures a set of geometric properties of a gap (G) between the work pieces (P1, P2). Thus, the welding head (110) can be properly positioned to attain a desired application of the weld material in the gap (G). Moreover, first adjustment means allow a position of the probe head (120) relative to a position of the welding head (110) to be varied angularly by rotating at least one of the probe head (120) and the welding head (110) around a first axis (A1) oriented essentially perpendicular to the welding plane (WP). Thereby, welding in narrow and curved gaps (G) is facilitated.

### THE BACKGROUND OF THE INVENTION AND PRIOR ART

The present invention relates generally to automatic precision welding. More particularly the invention relates to a welding device according to the preamble of claim 1.

Technical solutions for automatic welding have been known for decades. In many cases, the joints into which the weld material is applied are straight, and the work pieces perhaps inclined edges towards the joint. In such cases it is normally a straightforward task to weld together the work pieces in question. However, sometimes the welding becomes a more challenging undertaking, for example if the joint is circular, and/or very narrow.

U.S. Pat. No. 4,517,438 describes a rotary arc-welding apparatus having a rotatable nozzle for directing a consumable welding electrode toward a groove formed between objects of welding. The design includes a spring and brush arrangement to allow a rotating mechanism to rotate the nozzle about an axis at high speed so as to cause a circular movement of an arc from the tip of the consumable electrode. Hence, the apparatus is suitable for welding pipes and the like.

### PROBLEMS ASSOCIATED WITH THE PRIOR ART

It is normally a complex task to weld in narrow gaps, i.e. where the work pieces' edges towards the joint constitute essentially parallel surfaces, and these surfaces are located close to one another. This is especially true if the joint is curved. The above patent presets a solution for welding circular joints having a radius, which allows the passage of the nozzle through the groove between the objects to be joined. However, there is yet no general solution for welding in narrow circular gaps with very small radii, or in narrow and curved gaps having non-circular outlines.

### SUMMARY OF THE INVENTION

The object of the present invention is therefore to alleviate the above problems and offer a flexible and cost efficient solution for applying weld material in curved and narrow joints.

According to the invention, the object is achieved by the initially described arrangement, wherein the welding device includes first adjustment means configured to allow a position of the probe head relative to a position of the welding head to be varied angularly by rotating at least one of the probe head and the welding head around a first axis oriented essentially perpendicular to the welding plane.

This welding device is advantageous because the design allows automatic welding in very narrow joints having circular; as well as non-circular curved, outlines.

According to one preferred embodiment of the invention, the first adjustment means are associated with control means configured to lock the probe head relative to the welding head at a particular angle with respect to the first axis. Hence, the welding device can be conveniently optimized for welding circular joints having a certain radius.

According to another preferred embodiment of the invention, the welding device includes automatic control means configured to control the first adjustment means in response to a master signal, preferably being based on the set of geometric properties measured by the probe head. Thereby, during the transport of the welding device along the operating direction, an angular relationship between the probe head and the welding head may be varied adaptively with respect to the angle relative to the first axis. Naturally, this is advantageous when welding relatively complex curved joints, for instance with non-circular outlines.

According to yet another preferred embodiment of the invention, the first adjustment means includes manually controllable setting means configured to define the particular angle at which the probe head is locked relative to the welding head with respect to the first axis. Such an uncomplicated and cost efficient design is desirable when the requirements for quick adaptivity are relatively low.

According to still another preferred embodiment of the invention, the probe head includes two primary sensor members configured to register data representing at least a subset of the set of geometric properties of the gap between the work pieces. Each primary sensor member is here specifically configured to be in contact with a respective wall of the two work pieces adjoining the gap during the transport of the welding device along the operating direction. Thereby, for example a respective distance between a welding electrode and each of the work pieces can be calculated.

According to a further preferred embodiment of the invention, a proximal end of each primary sensor member is pivotably attached to a central element of the probe head. Moreover, each primary sensor member includes a distal end, and the probe head includes at least one resilient member configured to exert a repelling force on the primary sensor members relative to one another, so as to cause the distal ends thereof to maintain contact with the respective adjoining wall during the transport of the welding device along the operating direction while allowing vanation of the lateral distances between an electrode of the probe head and the adjoining walls. Thus, the geometric properties of the gap between the work pieces can be determined in a robust and reliable manner.

According to another preferred embodiment of the invention, the probe head includes optical sensor means configured to contactlessly register data representing at least a subset of the set of geometric properties of the gap between the work pieces. For many applications, this is a viable alternative, or complement, to the above-mentioned mechanical sensor members.

According to yet another preferred embodiment of the invention, the welding device includes second adjustment means configured to rotate the probe head relative to the welding head around a second axis, such that the welding head attains a tilt angle relative to the probe head. The second axis is oriented essentially parallel to the welding plane (i.e. essentially perpendicular to the first axis). Consequently, the welding action can be conveniently aimed at different areas inside the joint, for example to apply different weld beads therein.

According to still another preferred embodiment of the invention, the welding device includes a flux channel configured to apply flux in the gap between the work pieces. The flux channel has an outlet, which is arranged upstream of the welding head and downstream of the probe head relative to the operating direction. Thus, adequate amounts of flux can be applied without risk interfering with the measurement of joint profile's geometric properties.

According to a further preferred embodiment of the invention, the welding head is configured to administer the supply of at least one consumable electrode wire into the gap between the work pieces. Consequently, the welding process can be made highly efficient. It is also rendered possible to further adapt the welding to the specific properties of the joint.

Generally, the invention is beneficial because it enables high-precision welding in narrow joints with steep edges. The solution is therefore well suited for welding of reactor tanks and other demanding junctions of thick metal plates.

Additional advantages, advantageous features and applications of the present invention will be apparent from the following description and the dependent claims.

### BRIEF DESCRIPTION OF THE DRAWINGS

The invention is now to be explained more closely by means of preferred embodiments, which are disclosed as examples, and with reference to the attached drawings.

FIG. 1 schematically illustrates how a welding head and a probe head may be angled relative to one another according to the invention;

FIG. 2 illustrates how the proposed welding device may be used to apply welding material in a gap between two general work pieces;

FIG. 3a shows a control means according to a first embodiment of the invention;

FIG. 3b shows a control means according to a second embodiment of the invention;

FIG. 4 shows a specific example of how a welding device according to one embodiment of the invention can be used to join two work pieces;

FIG. 5 illustrates how a probe head according to one embodiment of the invention examines the gap between the work pieces to be joined;

FIG. 6 schematically illustrates how the welding head may be tilted relative to the probe head according to one embodiment of the invention; and

FIG. 7 shows a more detailed perspective view of the welding device in FIG. 5.

### DESCRIPTION OF PREFERRED EMBODIMENTS OF THE INVENTION

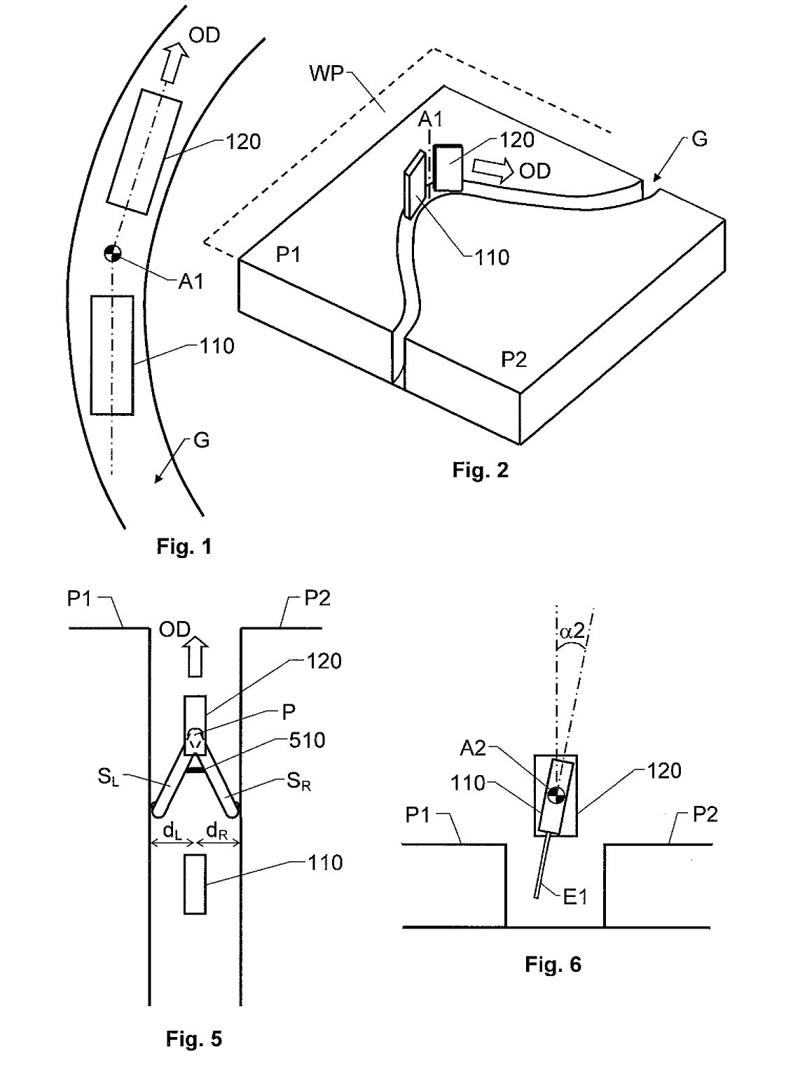

We refer initially to FIGS. 1 and 2. FIG. 1 schematically illustrates how a welding head 110 and a probe head 120 may be angled relative to one another according to the invention, and FIG. 2 shows a perspective view illustrating how this feature can be used to apply welding material in a curved gap G between two general work pieces P1 and P2.

The proposed welding device includes a welding head 110, a probe head 120 and first adjustment means. The welding head 110 is configured to perform a welding action in respect of the work pieces P1 and P2 during transport of the welding device along an operating direction OD in a welding plane WP. As a result, the two work pieces P1 and P2 become connected mechanically with one another. The welding plane WP is here an imaginary surface containing the path followed by the welding device. Provided that the work pieces P1 and P2 are flat, the welding plane WP is typically essentially parallel to the top surfaces of the work pieces P1 and P2.

The probe head 120 is arranged upstream of the welding head 110 relative to the operating direction OD. Further, the probe head 120 is configured to measure a set of geometric properties of a gap G between the work pieces P1 and P2, for example the width of the gap G and/or an estimated respective distance between a welding electrode and each of the work pieces P1 and P2 respectively. Thus, based on the set of geometric properties, it is possible to position the welding head 110 in the gap G so that a desired application of the weld material in the gap G is attained.

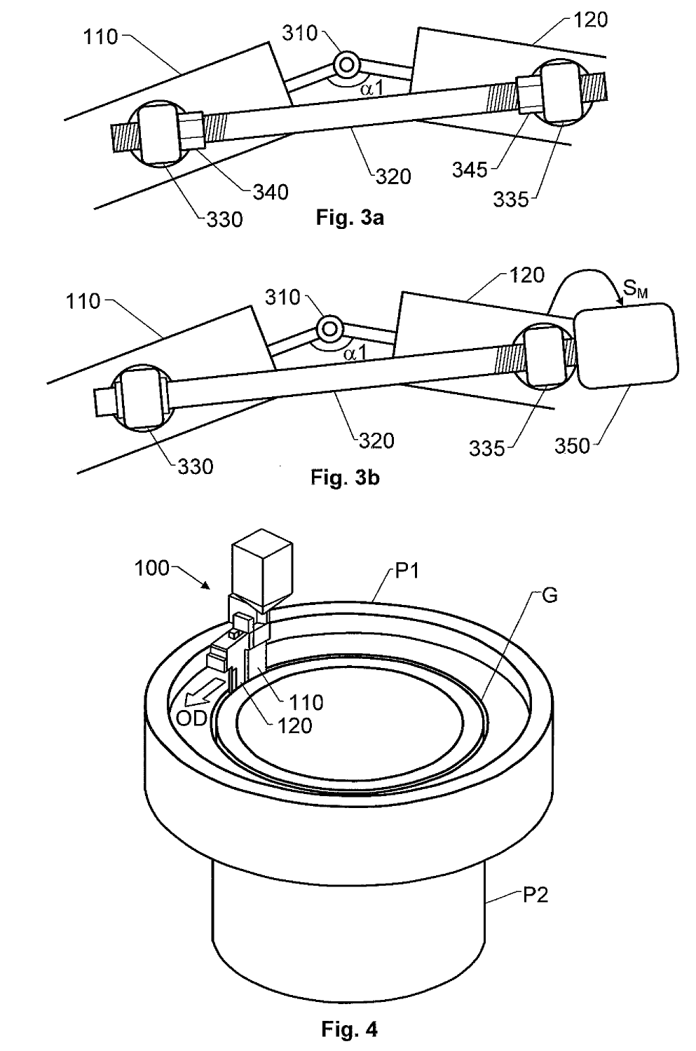

The first adjustment means preferably includes a joint (e.g. represented by a hinge or a pivot) and are configured to allow a position of the probe head 120 relative to a position of the welding head 110 to be varied angularly by rotating at least one of the probe head 120 and the welding head 110 around a first axis A1 oriented essentially perpendicular to the welding plane WP. The first adjustment means will now be described in further detail with reference to FIGS. 3a and 3b.

FIG. 3a shows the first adjustment means having a joint 310 and a control means according to a first embodiment of the invention. The first axis A1 passes through the joint 310, which allows the welding head 110 to be angled in relation to the probe head 120 as described above. Moreover, the first adjustment means are associated with control means 320 330 335, 340 and 345 configured to lock the probe head 120 relative to the welding head 110 at a particular angle α1 with respect to the first axis A1. Here, the control means include a rod 320, flexible attachment points 330 and 335 on the welding head 110 and the probe head 120 respectively and locking bolts 340 and 345. The rod 320 interconnects the flexible attachment points 330 and 335, and the locking bolts 340 and 345 are arranged on the rod 320 to enable the distance between the probe head 120 and the welding head 110 to be fixed, such that the angle α1 there between attains a particular value. The locking bolts 340 and 345 are manually controllable via a suitable tool, for instance a torque wrench.

FIG. 3b shows a control means according to a second embodiment of the invention. The design is here essentially the same as that in FIG. 3a. However, according to the second embodiment, the welding device includes automatic control means, such as an electric motor 350. The electric motor 350 is arranged on the rod 320 and is configured to rotate the rod 320, so that in response thereto the first angle α1 of the first adjustment means 310 varies. The electric motor 350, in turn, is controlled in response to a master signal S_{M}, which is preferably based on the set of geometric properties measured by the probe head 120. Consequently, during the transport of the welding device along the operating direction OD, the automatic control means may adaptively adjust the angular relationship between the probe head 120 and the welding head 110, such that this relationship varies with respect to the angle α1 relative to the first axis A1 in a manner being adapted to the properties of the gap G. If the angle α1 is to attain values over 180° (to handle curves in the opposite direction) auxiliary control means (not shown) in addition to the rod 320 and the electric motor 350 may be required.

FIG. 4 shows a specific example where a welding device 100 according to one embodiment of the invention is used to join two work pieces P1 and P2 in the form of a coupling piece and a pipe respectively. In this case, since the gap G between the work pieces P1 and P2 has a constant radius, the probe head 120 is preferably locked relative to the welding head 110 at a particular angle α1 with respect to the first axis A1 according to the first embodiment above. Nevertheless, a design according to the second embodiment is equally well applicable also here.

FIG. 5 illustrates how the probe head 120 according to one embodiment of the invention is configured to examine the gap G between two work pieces P1 and P2 to be joined. The probe head 120 of this embodiment includes two primary sensor members S_{R} and S_{L} that are configured to register data representing at least a subset of the above-mentioned set of geometric properties of the gap G between the work pieces P1 and P2. During the transport of the welding device along the operating direction OD, each of the primary sensor members S_{R} and S_{L} is configured to be in physical contact with a respective wall W1 and W2 of the two work pieces P1 and P2, which walls W1 and W2 adjoin the gap G.

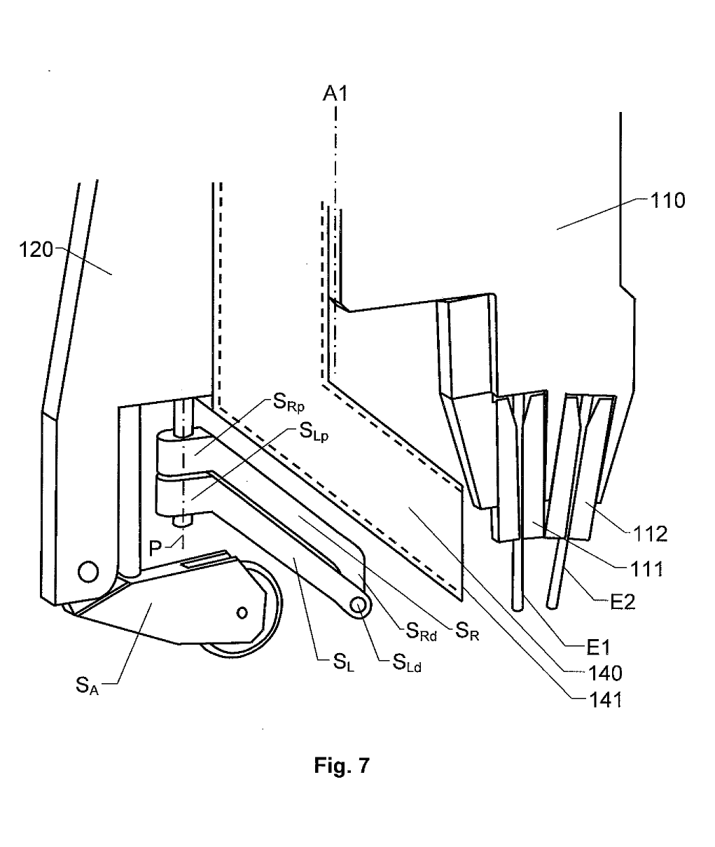

To this aim, a proximal end S_{RP} and S_{LP} respectively of each of the primary sensor members S_{R}, and S_{L} is preferably pivotably attached to a central element of the probe head 120 via a pivot axis P. Each of the primary sensor members S_{R} and S_{L} has a distal end S_{Rd} and S_{Ld} respectively. Further, at least one resilient member 510 is arranged to exert a repelling force on the primary sensor members S_{R} and S_{L} relative to one another. As a result, the distal ends S_{Rd} and S_{Ld} are separated by rotation of the primary sensor members S_{R} and S_{L} around the pivot axis P, and the distal ends S_{Rd} and S_{Ld} are brought to maintain contact with the respective adjoining wall W1 and W2 during the transport of the welding device along the operating direction OD. At the same time, lateral distances d_{R} and d_{L} respectively may be varied between an electrode E1 (see FIGS. 6 and 7) of the probe head 120 and the adjoining walls W1 and W2 depending on the geometric characteristics of the gap G and how the welding device's path therein is controlled.

For optimal welding in larger joints (i.e. where the gap G is relatively wide and/or deep), it is generally preferable if the welding head 110 may be tilted relative to a position of the probe head 120 during the welding process, such that weld material can be applied in a tailored manner to specific areas within the joint depending on the geometric properties of joint and/or where any previous weld beads have already been applied. FIG. 6 schematically illustrates how the welding head 110 may be tilted relative to the probe head 120 according to one embodiment of the invention, and thus reach specific areas within the joint. According to this embodiment, the welding device has second adjustment means (not shown), which second adjustment means are configured to rotate the probe head 120 relative to the welding head 110 around a second axis A2, such that the welding head 110 attains a tilt angle α2 relative to the probe head 120. The second axis A2 is here oriented essentially parallel to the welding plane WP, i.e. essentially perpendicular to the first axis A1.

FIG. 7 shows a more detailed perspective view of the welding device 100 in FIG. 5. As can be seen, the welding device 100 includes the mechanical type of primary sensor members S_{R} and S_{L} described above with reference to FIG. 5. According to one embodiment of the invention, however, the probe head 120 is instead equipped with optical sensor means configured to contactlessly register data representing at least a subset of the set of geometric properties of the gap G between the work pieces P1 and P2. The optical sensor means preferably include a powerful light source in the form of a LED (light emitting diode) or a laser unit. Such optical sensor means are advantageous by rendering a reliable and compact design possible. Acoustic sensor means may be used as yet another alternative, or complement.

To enable submerged arc welding, the welding device 100 may further include a flux channel 140 that is configured introduce flux into the gap G between the work pieces P1 and P2. The flux channel 140 has an outlet 141, which is arranged upstream of the welding head 110 and downstream of the primary sensor members S_{R} and S_{L} relative to the operating direction OD.

According one preferred embodiment of the invention, the welding head 110 is configured to administer the supply of one or more consumable electrode wires into the gap G between the work pieces P1 and P2. FIG. 7 shows two such electrode wires E1 and E2. Thus, the welding head 110 is provided with at least two wire outputs 111 and 112 configured to feed out a respective electrode. The outputs 111 and 112 are preferably arranged such that a stick-out of a first electrode E1 is angled relative to a stick-out of a second electrode E2. Namely, thereby the welding process can be made highly efficient. It is also rendered possible to further adapt the welding to the specific properties of the joint.

The term “comprises/comprising” when used in this specification is taken to specify the presence of stated features, integers, steps or components. However, the term does not preclude the presence or addition of one or more additional features, integers, steps or components or groups thereof.

The reference to any prior art in this specification is not, and should not be taken as, an acknowledgement or any suggestion that the referenced prior art forms part of the common general knowledge in Australia, or any other country.

The invention is not restricted to the described embodiments in the figures, but may be varied freely within the scope of the claims.

1-11. (canceled)

12. A welding device for applying weld material between two work pieces to connect the work pieces mechanically with one another, the welding device comprising:
a welding head configured to perform a welding action in respect of the work pieces during transport of the welding device along an operating direction in a welding plane, and
a probe head arranged upstream of the welding head relative to the operating direction, the probe head configured to measure a set of geometric properties of a gap between the work pieces to enable positioning of the welding head to apply weld material in the gap,
wherein that the welding device comprises a first adjustable coupling to allow a position of the probe head relative to a position of the welding head to be varied angularly by rotating at least one of the probe head and the welding head around a first axis oriented perpendicular to the welding plane.

13. The welding device according to claim 12, wherein the first adjustable coupling is associated with a control mechanism to lock the probe head relative to the welding head at an angle with respect to the first axis.

14. The welding device according to claim 12, comprising a control mechanism configured to control the first adjustable coupling in response to a master signal such that during the transport of the welding device along the operating direction an angular relationship between the probe head and the welding head varies with respect to the angle relative to the first axis.

15. The welding device according to claim 14, wherein the master signal is based on the set of geometric properties measured by the probe head.

16. The welding device according to claim 13, wherein the first adjustable coupling comprises a manually controllable locking assembly configured to define the angle at which the probe head is locked relative to the welding head with respect to the first axis.

17. The welding device according to claim 12, wherein the probe head comprises two primary sensor members configured to register data representing at least a subset of the set of geometric properties of the gap between the work pieces, each of the primary sensor members configured to be in contact with a respective wall of the two work pieces adjoining the gap during the transport of the welding device along the operating direction.

18. The welding device according to claim 17, wherein a proximal end of each of the primary sensor members is pivotably attached to a central element of the probe head, each of the primary sensor members comprising a distal end, the probe head further comprising at least one resilient member configured to exert a repelling force on the primary sensor members relative to one another so as to cause the distal ends thereof to maintain contact with the respective adjoining wall during the transport of the welding device along the operating direction while allowing variation of lateral distances between an electrode of the probe head and the adjoining walls.

19. The welding device according to claim 12, wherein the probe head comprises an optical sensor configured to contactlessly register data representing at least a subset of the set of geometric properties of the gap between the work pieces.

20. The welding device according to claim 12, comprising second adjustable coupling configured to rotate the probe head relative to the welding head around a second axis such that the welding head attains a tilt angle relative to the probe head, the second axis being oriented parallel to the welding plane.

21. The welding device according to claim 12, comprising a flux channel configured to apply flux in the gap between the work pieces, the flux channel having an outlet positioned upstream of the welding head and downstream of the probe head relative to the operating direction.

22. The welding device according to claim 12, wherein the welding head is configured to supply at least one consumable electrode wire into the gap between the work pieces.
